(19) United States
(12) Patent Application Publication
(10) Pub. No.: US 2026/0077245 A1
(43) Pub. Date: Mar. 19, 2026

(54) Pickleball Ball Wear and Tear Indicators and Detectors

(71) Applicant: Ofinno, LLC, Reston, VA (US)

(72) Inventors: Aaron GORE, Fairfax, VA (US); Esmael Hejazi DINAN, McLean, VA (US)

(21) Appl. No.: 19/329,896

(22) Filed: Sep. 16, 2025

Related U.S. Application Data
(60) Provisional application No. 63/695,338, filed on Sep. 16, 2024.

(51) Int. Cl. A63B 37/14; A63B 37/00; A63B 43/00; A63B 71/06; A63B 102/08; G06T 7/00; G06T 7/40; G06T 7/90; G06V 20/64

(52) U.S. Cl. CPC A63B 37/14; A63B 37/0098; A63B 43/004; G06T 7/0002; G06T 7/40; G06T 7/90; G06V 20/64; A63B 2071/0694; A63B 2102/08; A63B 2220/17; A63B 2220/833; A63B 2225/54; G06T 2207/30224

(57) ABSTRACT

A pickleball ball comprising a hollow sphere with a plurality of holes arranged on the hollow sphere and an attached or integrated wear-and-tear indicator is described. In some examples, the wear-and-tear indicator may comprise a multi-layered painted indicator on the outer surface of the hollow core. The multi-layered painted indicator may be applied throughout the outer surface. The multi-layered painted indicator may comprise two or more layers of different materials with different durability characteristics. The different materials may each have a different color and/or texture.

### CROSS REFERENCE TO RELATED APPLICATIONS

This application claims priority to U.S. Provisional Application No. 63/695,338 filed Sep. 16, 2024, the entire content of which is herein incorporated by reference.

### FIELD

This disclosure relates to pickleball, and more particularly to pickleball balls.

### BACKGROUND

Pickleballs balls that are available in the market are made of one plastic type. The material composition may be tailored to particular playing surfaces. The characteristic of the plastic type is a key factor that determines the durability, bounce, hardness and weight of the ball. Typically, a pickleball ball is considered to last for 3-5 games at maximum performance before it is typically recommended to be switched out.

Due in part to pickleball balls having hard surfaces and pickleball courts also being hard, pickleball balls can get deformed, cracked, and/or lose some performance over a relatively short period of use. The use of a ball that is either too old or has been used too many times, may affect the ball's flight characteristics, the ball's bounce, and/or how the ball projects when hit with the paddle. Therefore, many players prefer to ensure that they use only new or relatively minimally used pickleball balls for their games.

Players often need to inspect a pickleball ball for cracks or proper spherical form to make sure that the balls are either new or are not excessively used. Sometimes, players are not able to identify issues with a damaged pickleball. Although some crack-resistant balls are available, they may tend to get deformed after a few games. Currently, there is no reliable way to determine how much a pickleball ball has been used. Therefore, there is a need for improved techniques to indicate how much a pickleball ball is used and/or whether the ball is damaged.

### SUMMARY OF EXAMPLE EMBODIMENTS

An embodiment provides a pickleball ball comprising a hollow sphere with a plurality of holes arranged on the hollow sphere and an attached or integrated wear-and-tear indicator.

The wear-and-tear indicator may comprise a multi-layered painted indicator on the outer surface of the hollow core. The multi-layered painted indicator may be applied throughout the outer surface. The multi-layered painted indicator may comprise two or more layers of different materials with different durability characteristics. The different materials may each have a different color and/or texture.

In some embodiments, the multi-layered painted indicator may be applied in the form of a shape, text, or logo.

In some embodiments, the wear-and-tear indicator may comprise a shape, text, or logo, formed with a paint of predetermined durability, on an outer surface of the hollow shell. The predetermined durability may be determined in terms of a number of impacts.

In some embodiments, the wear-and-tear indicator may comprise a first painted indicator on the outer surface of the hollow core and a second painted indicator on the outer surface of the hollow core, wherein the first painted indicator and the second indicator are configured with different durability characteristics.

The first painted indicator may comprise a first plurality of markings distributed on the outer surface and the second painted indicator may comprise a second plurality of markings distributed on the outer surface. The first painted indicator may comprise first one or more connected lines on the outer surface and the second painted indicator may comprise second one or more connected lines on the outer surface.

In some embodiments, the first plurality of lines and the second plurality of lines are alternated on the outer surface.

In some embodiments, the wear-and-tear indicator may comprise a microchip integrated on the inner surface of the hollow sphere, wherein the microchip is configured to track a number of impacts, a number of games left, and/or one or more performance characteristics. The tracked number of impacts may be collected for each of a plurality of levels of impacts. Tracked performance characteristics may include a stress level of the hollow sphere.

In some embodiments, the wear-and-tear indicator may comprise a RFID tag integrated on the inner surface of the hollow sphere.

In some embodiments, the wear-and-tear indicator may comprise a layer of material on a wall of one or more of the holes. The layer of material may be configured to change a characteristic in proportion to a use of the ball. The layer of material may be configured to change a color and/or a texture in accordance with a use of the ball.

In some embodiments, the wear-and-tear indicator is a sticker attached to an outer surface of the hollow sphere.

An embodiment provides a pickleball ball wear-and-tear detector comprising an inspection area to hold the ball, an imaging device to capture one or more images of the ball in the inspection area, and a processor configured to control the imaging device to capture the one or more images of the ball. The processor may be further configured to rotate the ball in the inspection area and to control the imaging device to capture the one or more images in coordination with the rotation of the ball. The imaging device may be configured to capture imaging of an entire surface of the ball, and/or the processor may be configured to detect cracks and/or deformations of the ball.

In some embodiments, the detector may further comprise a display and/or one or more indicator lights, wherein the processor is configured to analyze the one or more images to determine a status of the ball and to control the display and/or the one or more lights to indicate information about the determined status.

### BRIEF DESCRIPTION OF THE DRAWINGS

Some features are shown by way of example, and not by limitation, in the accompanying drawings. In the drawings, like numerals may reference similar elements.

FIG. 1A shows an example pickleball court, in which embodiments of the present disclosure may be applied.

FIG. 1B shows another view of a pickleball court.

FIG. 2A shows a pickleball ball with a new ball indicator sticker attached, according to an embodiment.

FIG. 2B shows a pickleball ball with a wear-and-tear indicator paint marking, according to some embodiments.

FIG. 2C shows a pickleball ball with two levels of wear-and-tear indicators, according to some embodiments.

FIG. 3A-3C show pickleball balls with wear-and-tear indicators in the form of lines or strips on the outer surface of the ball, according to some embodiments.

FIG. 4A shows a pickleball ball wear-and-tear detection apparatus according to some embodiments.

FIG. 4B and FIG. 4C show example area scanning and line scanning in the pickleball ball wear-and-tear detection apparatus shown in FIG. 4A, according to some embodiments.

FIG. 5 shows an example of ball deformity detection in the pickleball ball wear-and-tear detection apparatus shown in FIG. 4A, according to some embodiments.

FIGS. 6A and 6B show examples of determining of dimensions of a ball in a pickleball ball wear-and-tear detection apparatus as shown in FIG. 4A, according to some embodiments.

FIG. 6C shows an example of cracks on a pickleball ball that can be detected in a pickleball ball wear-and-tear detection apparatus, according to some embodiments.

FIG. 7 shows a pickleball ball with a wear-and-tear monitoring microchip, according to some embodiments.

### DETAILED DESCRIPTION OF EXAMPLE EMBODIMENTS

In the following description, numerous specific details are set forth in order to provide a thorough understanding of the disclosure. However, it will be apparent to those skilled in the art that the disclosure may be practiced without these specific details. The description and representation herein are the common means used by those experienced or skilled in the art to most effectively convey the substance of their work to others skilled in the art. In other instances, well-known methods, procedures, and components have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

This disclosure relates to “Pickleball,” a game that has in recent years seen a massive increase in popularity among all age groups of players, including among senior citizens. Pickleball is a game that can be described as combining aspects of tennis, badminton, and ping-pong. It is played on a badminton-sized court, with paddles and a ball similar to a wiffle ball, but slightly smaller in size. The net used in pickleball is similar to a tennis net in some ways, but is lowered at the center.

Pickleball has recently become very popular and is played both indoors and outdoors, as either doubles or singles. The rules are relatively simple and the game is easy for beginners to learn. However, among skilled players, pickleball can develop into a quick, fast-paced, and competitive game.

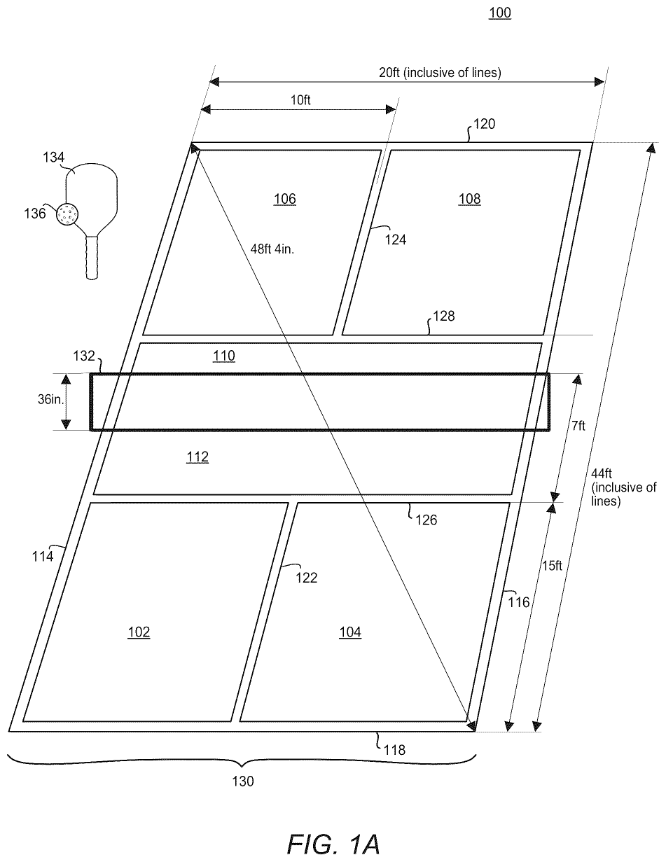

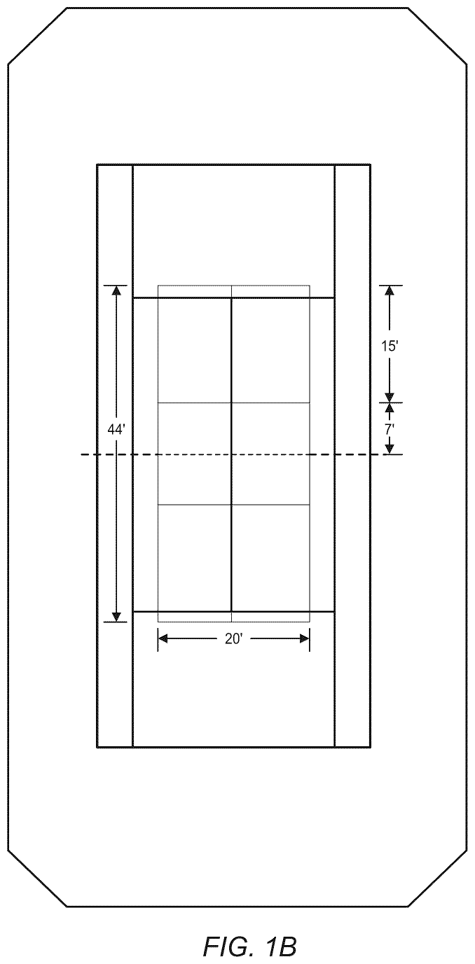

FIG. 1A shows an example pickleball court 100 that includes a pickleball playing surface 130 and a pickleball net 132. The playing surface 130 comprises two left serve areas 102 and 108, two right serve areas 104 and 106, and two non-volley areas 110 and 112, with one of the left serve areas, one of the right serve areas, and one of the non-volley areas being on each side of the pickleball net 132. The net is 36 inches tall at the edges, and lowered to 34 inches in the middle. The areas 102-112 are defined by baselines 118 and 120 each 20 feet, sidelines 114 and 116 each 44 feet, center lines 122 and 124 each 15 feet, and non-volley lines 126 and 128 each the same size as a baseline. Each of the lines may be 2 inches wide. The term “court line” is used in this disclosure to refer to any sideline, baseline, centerline or non-volley line on the pickleball court. Non-volley areas 110 and 112, each extending 7 feet from the net, are also referred to as the “kitchen”.

The game of pickleball is played with a pickleball paddle 134 and pickleball ball 136. The ball 136 is typically made of plastic and has a 3-inch diameter. Similar to a wiffleball, the ball 136 has through holes throughout the surface. Different types (e.g., with different levels of hardness and different sizes of the through holes) may be used for playing the game on the various types of pickleball courts (e.g., indoor, outdoor, hard surface, soft surface etc.).

Pickleball can be played as singles or doubles, and is most commonly played as doubles. Each point begins with an underarm serve. The serve is performed diagonally beginning at the right-hand service square. A valid serve sends the ball from one left serve area to the other left serve area or from one right serve area to the other right serve area. The serve must clear the non-volley-zone. The serve must bounce before being hit by the receiver. The return of serve must also bounce before being hit (this is known as the 2 bounce rule). After the serve and the return of the serve, the ball can land anywhere on the opposite side of the playing surface 130. Volleys can only be performed outside of the non-volley zone. Volleys, that is, hitting the ball in the air without first letting it bounce, can only be made after the 2 bounce rule has been followed. However, if the ball is hit from within the kitchen, then it cannot land in the kitchen on the other side of the net.

A fault is any action that stops play due to a rule violation. A fault by the receiving team results in the servers earning a point. A fault by the serving team results in the server's loss of service and/or side out. A fault is committed when the serve touches any part of the non-volley zone (including the line) or the ball is hit out of bounds.

Pickleball games are typically played without a referee and are self-judged. Each player makes the line calls as to whether the ball is in or out when the ball contacts the playing surface on that player's side. The game continues to at least 11 points and requires a 2-point difference for a win. FIG. 1B shows another view of a pickleball court.

The specifications for regulation use pickleball balls are provided by USA Pickleball Association (USAPA). The specifications regulate aspects of construction, size, bounce, compression, and design for pickleball balls. Many tournaments may require the use of pickleball balls that fully comply with the USAPA specifications.

According to USAPA specifications, the circumference of the pickleball ball should be 9.03″-9.34″ (22.93-23.72 cm), and the diameter should be 2.874″-2.972″ (73-75.5 mm). The maximum out-of-round diameter variance shall not be greater than +/−0.020 inch (0.51 mm). The ball is to be made of a durable material molded with a smooth surface and free of texturing, and should be one uniform color except for identification markings. The ball may have a slight ridge at the seam as long as it does not significantly impact the ball's flight characteristics.

The ball weight should be between 0.78 and 0.935 ounces (22.1 and 26.5 grams). The ball should have a bounce of 30 to 34 inches (76.2 to 86.4 cm) to the top of the ball when dropped from a height of 78 inches (198.1 cm) onto a granite surface plate that is a minimum of 12 inches (30.5 cm) by 12 inches (30.5 cm) by 4 inches (10.2 cm). A maximum compression is also specified. Previous specifications also specified a hardness of 40 to 50 on a Durometer D scale. The bounce, compression and hardness specifications are at an ambient temperature of 70 degrees F plus or minus 5 degrees F.

The specification also states that the ball is to have a minimum of 26 to a maximum of 40 circular holes, with spacing of the holes and overall design of the ball conforming to flight characteristics. The ball must have a manufacturer's or supplier's name or logo printed or embossed on the surface.

One technique of manufacturing pickleball balls is a process referred to as injection molding. The core ingredient is very often polyethylene-a type of plastic known for its toughness and elasticity. However, the type of plastic can differ depending on whether the ball is for indoor or outdoor play. Indoor balls use softer plastic (e.g., polypropylene) for better control on smooth surfaces, while outdoor balls have shells made of harder plastic to endure the wear and tear of rough courts like asphalt or concrete.

The injection molding process involves melting down the plastic into a liquid state and then forcing the liquid plastic with high pressure into a mold made of two halves. These molds are designed to create the exact shape and size of a pickleball, including the holes on the surface. The pressure ensures the plastic fills the mold in a manner that results in a consistent ball construction throughout. The two halves of the filled mold are then fused together forming a complete ball. Thereafter, the new ball cools down until the plastic hardens and retains its shape.

Rotational molding is another process that is used for manufacturing pickleballs. In this technique, plastic powder is poured into a heated mold that rotates on two axes. As the mold rotates, the plastic melts and coats the inside evenly. The mold is then cooled, and the finished ball is removed. In general, rotational molding is considered a less-costly process than injection molding, but it offers less flexibility in the ball design. Thus, injection molding is generally preferred.

Pickleballs balls that are available in the market are made of one plastic type. The material composition may be tailored to particular playing surfaces. As mentioned above, for indoor pickleball, balls are made with a softer plastic, like polypropylene, for better control on smooth gym floors. The softer plastic materials are considered to provide more precise volleys and softer touches. For outdoor pickleball, balls that have tougher shells of harder plastic, like polyethylene, to withstand the demands of asphalt or concrete courts are used. Such tougher shells are more resilient to wear and tear and have a faster, livelier bounce for outdoor rallies.

The characteristic of the plastic type is a key factor that determines the durability, bounce, hardness and weight of the ball. Typically, a pickleball ball is considered to last for 3-5 games at maximum performance before it is typically recommended to be switched out.

Due in part to pickleball balls having hard surfaces and pickleball courts also being hard, pickleball balls can get deformed, cracked, and/or lose some performance over a relatively short period of use. In regular day-to-day scenarios, players retrieve a ball for a game from a collection of balls that may have balls of various manufacturing dates, and a range of levels of use. After being used in games for many hours, pickleball balls may lose some of their performance characteristics, lose their spherical forms, or get cracked. The quality of the ball may significantly affect the quality of a pickleball game. The use of a ball that is either too old or has been used too many times, may affect the ball's flight characteristics, the ball's bounce, and/or how the ball projects when hit with the paddle. Therefore, many players prefer to ensure that they use only new or relatively minimally used pickleball balls for their games.

Players often need to inspect a pickleball ball for cracks or proper spherical form to make sure that the balls are either new or are not excessively used. Sometimes, players are not able to identify issues with a damaged pickleball. Although some crack-resistant balls are available, they may tend to get deformed after a few games. Currently, there is no reliable way to determine how much a pickleball ball has been used. Therefore, there is a need for improved techniques to indicate how much a pickleball ball is used and/or whether the ball is damaged.

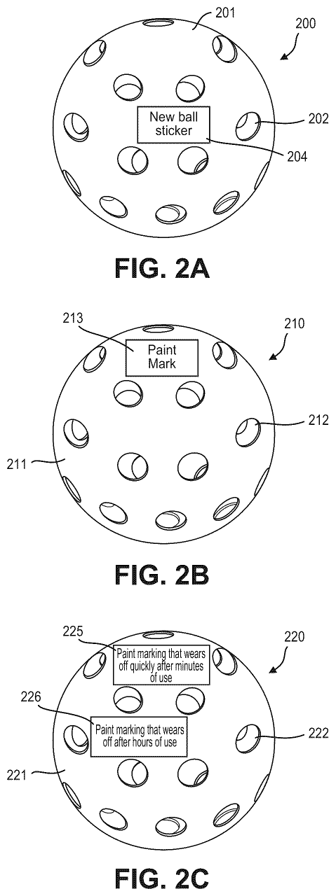

FIG. 2A shows a pickleball ball with a new ball indicator sticker attached. The pickleball ball 200 has a hollow spherical shell 201 that includes a plurality of holes (through holes) 202. The sticker 204 attached to the outer surface 201 of the ball 200 indicates that the pickleball ball is new (i.e., unused). The sticker 204 may be a separate label to be peeled or scratched off from the pickleball before the pickleball is used. It is useful for tournament play, as the player can remove the sticker before the start of the game.

FIG. 2B shows a pickleball ball with a wear-and-tear indicator paint marking, according to some embodiments. The pickleball ball 210 has a spherical shell 211 that includes a plurality of through holes 212. The wear-and-tear indicator 213 is a paint marking made with a paint of known durability characteristics. The paint layer is configured to wear with use, in order to let players to readily know that the ball's performance may be decreased. The paint marking 213 shown in FIG. 2B is a rectangle. However, the paint marking 213 can be in any shape, in the form of text, and/or in the form of a logo.

The paint may use any type of chemical blend that causes the paint to wear off and/or change color when the ball is used over a predetermined threshold level of use. The paint wear may correlate with the level of use, and thereby may also correlate with the ball's performance. The paint may be configured such that, after the ball is played for a predetermined threshold level of use, the paint marking wears off and that indicates that the ball has been extensively used and needs to be replaced. For example, the paint may substantially wear off after 5 hours of moderate use. In some embodiments, instead of wearing off, or in addition to that, the paint may change color when the ball exceeds the predetermined threshold level of use.

The paint is made up of several key components: a binder (which holds the pigment together), a pigment (that provides color), an extender (used to modify consistency and sometimes reduce cost), a solvent (that thins the paint for application), and additives (which enhance specific properties of the paint). Durability of the paint refers to: adhesion (the paint's ability to stick to the substrate), resistance (to factors like abrasion, weathering, chemicals, and water), and longevity (the paint's lifespan before showing signs of degradation). To alter durability for embodiments, various components within the paint's formulation can be manipulated.

In some embodiments, the paint marking is formed by enhancing a baseline acrylic latex paint formulation. The baseline comprises an acrylic copolymer (binder), titanium dioxide (pigment), calcium carbonate (extender), water, and additives (coalescing agent, thickener, preservative, defoamer). To enhance the durability of the baseline formulation, the options explored for embodiments include: increasing the binder content, selecting durable pigments, and/or introducing durability enhancing adhesives. To increase the binder content, a higher percentage of acrylic copolymer can be used. This provides a thicker, more robust film. Additionally, or alternatively, a modified acrylic with improved adhesion properties can be used. In order to select durable pigments, some titanium dioxide can be replaced with more durable pigments, like zinc oxide, which offers better UV resistance. In order to introduce durability enhancing additives, a silane or epoxy-based adhesion promoter can be introduced to strengthen the bond between paint and substrate. Alternatively, or additionally, a UV stabilizer can be added to protect the paint from degradation caused by sunlight, and/or a flexibilizer may be introduced to improve the paint's ability to withstand expansion and contraction.

In one embodiment, a paint comprising an increased percentage of acrylic copolymer, a pigment blend using titanium dioxide and zinc oxide, calcium carbonate, water, and a collection of additives including a coalescing agent, thickener, preservative, defoamer, adhesion promoter, UV stabilizer, and a flexibilizer, is used for the paint marking. More particularly, in one embodiment, a mix of acrylic resin (25%) as the binder, titanium dioxide (15%) as pigment, calcium carbonate (20%) as extender, DPGME (5%) as coalescing agent, hydroxyethyl cellulose (1%) as thickener, MIT (0.1%) as preservative, silicone-based defoamer (0.05%) as defoamer, and water (33.85%) was used, followed by adjusting the levels of adhesion promoter to achieve wear-and-tear indication at predetermined use levels of the ball. The forming of the paint may follow the usual process of paint creation: the pigment and the extender are first dispersed in water using dispersants and milling equipment to create a paste, then the acrylic resin is emulsified in water to form a latex emulsion, and then all components are mixed together to form the paint. This is followed by adding additives like thickeners, preservatives, defoamers, and adhesion promoter, to achieve desired properties.

In another embodiment, the outer surface of the spherical shell of the pickleball ball may be a thin layer of plastic over another one or more layers. The outer layer of the another one or more layers has a color that is different from the color of the outer surface of the ball. The outer layer of ball wears to reveal a paint layer which indicated performance is decreased

A thin outer layer may be added to the ball that has a different color than the internal layer. When the ball is extensively used, the outer layer gradually wears off, and the internal layer will be revealed. This may indicate that the ball has been extensively used and needs to be replaced.

In some embodiments, the paint marking may be made with a paint that includes a top layering and a bottom layering with the bottom layering incorporating color changing microcapsules that when ruptured due to impact changes color or microcapsules that when ruptured due to impact releases reactive components that mixes with the environment to change color. The microcapsules in the bottom layer are directly exposed to impact when the top layer is worn out. The thickness of the top layer can be configured to achieve different levels of use indication.

In another embodiment, the surface of the hollow sphere is covered with the paint marking formed according to any one of the above techniques. As the ball is used, the paint marking wears off and subsequently, the paint marking is recognizably indicative of the level of use.

FIG. 2C shows a pickleball ball with two levels of wear-and-tear indicators, according to some embodiments. The pickleball ball 220 has a hollow spherical shell 221 that includes a plurality of through holes 222. The wear-and-tear indicators 225 and 226 are paint markings each with a different paint of known durability characteristics. Each of the paint markings can be formed using any of the techniques noted above.

In some embodiments, two types of paint markings are arranged on the surface of the ball: a first paint marking (e.g., paint marking 225) that wears off quickly after minutes of use, and a second paint marking (e.g., paint marking 226) that wears off after hours of use. In some embodiments, the marking 225 determines whether the pickleball is a new ball or not, and the marking 226 determines whether the pickleball is extensively used and should be replaced.

In some embodiments, paint markings for indicating a single level of wear-and-tear or paint markings for indicating two or more levels of wear-and-tear are applied on the inner wall of one or more of the through holes. The one or more paints can be configured for indicating different levels of wear-and-tear in a manner similar to that described above, in relation to embodiments in which the paint markings are on the outer surface of the ball. Unlike the outer surface of the ball, the inner walls of the through holes are not directly hit by the paddle or hit on the ground, and therefore the wear-and-tear characteristics are often different from those on the outer surface. In embodiments in which the inner wall of one or more through holes are applied with a paint mark, the wear-and-tear indication can be obtained based on the status of the paint marking at the edge of the painted through hole. This is because with each impact on the surface of the ball, the area around the through holes that are closest to the impact are subjected to the highest levels of ball surface vibrations from the impact and also the highest amounts of flex on the ball surface.

The paint markings of example embodiments provide players the confidence that they are playing with a high performing ball and will know when to replace a ball as soon as performance starts to degrade.

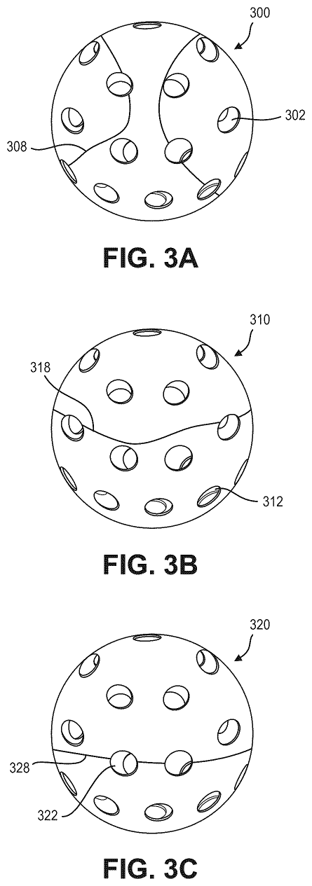

FIG. 3A-3C show pickleball balls with wear-and-tear indicators in the form of lines or strips on the outer surface of the ball, according to some embodiments. Example markings can be any of pattern (e.g., square, circle, dots, lines).

The lines or strips are markings to show if a pickleball is a new ball or if a ball is worn out or is extensively used. In some embodiments, the markings may be localized on the ball.

This is easier to implement, however the paint may wear off if that area is hit multiple time. In some embodiments, the markings may be a line covering a wider perimeter of the ball. Such an indicator may be more reliable, as the marking covers multiple sides of the ball.

FIG. 3A shows an example pickleball ball 300 with a wear-and-tear indicator 308 that is a strip of paint marking. The marking 308 is localized. FIG. 3B shows another example pickleball ball 310 having a wear-and-tear indicator 318 that is a strip of paint marking. FIG. 3C shows another example pickleball ball 320 with a wear-and-tear indicator 328 that is a strip of paint marking. The strip 328 is drawn on the circumference of the ball and thus provides a larger coverage than the strips 318 or 308.

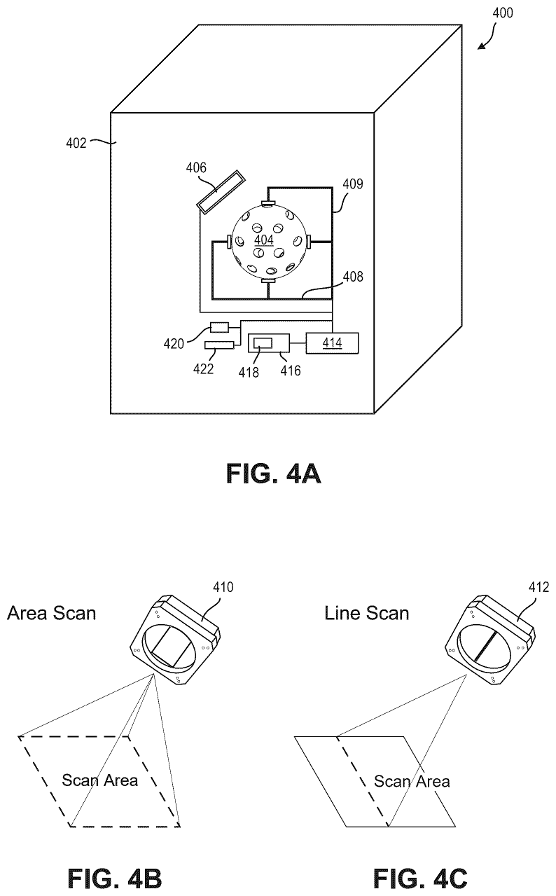

FIG. 4A shows a pickleball ball wear-and-tear detection apparatus according to some embodiments. The wear-and-tear detection apparatus 400 includes an inspection area 402 in which to place the pickleball ball 404 for inspection by imaging. At least one imaging device 406 is configured to capture images of the ball 404 inside the inspection area 402. In some embodiments, a ball rotation apparatus (e.g., comprising of vertical rotation arm 409 and horizontal rotation arm 406) is configured to rotate the ball on the horizontal axis and/or on the vertical axis. The imaging device 406 and the rotation apparatus are configured to be controlled by at least one processor 414 electrically connected to the imaging device and the rotation apparatus. The imaging device 406 may be a camera. The ball rotation apparatus, such as the illustrated horizontal rotation arm 408 and vertical rotation arm 409, may have retractable holding arms that can be activated/extended at intervals to hold the ball and rotate in each direction in coordination with image capturing by the imaging device so that 360 degree coverage of the ball can be obtained.

The illustrated detection apparatus 400 comprises one imaging device 406. However, some embodiments, the wear-and-tear detection apparatus can include one or more imaging devices that can move, while the ball remains stationary and without rotation, to capture the entire surface of the ball. In some embodiments, there may be several cameras in fixed positions to capture the entire surface of the ball. In some embodiments, the ball may be positioned on a surface within the inspection chamber where the surface is configured to rotate the ball in different directions such that a stationary camera can capture images of the entire surface.

At least one processor 414 may control the detection apparatus 400. In some embodiments, a wear-and-tear detection program 418 that is stored in a non-transitory storage device and/or digital memory.

In some embodiments, the detection apparatus 400 may further comprise a display 420 and/or one or more indicator lights (e.g., LEDs of multiple colors) 422.

The at least one processor 414 may operate in accordance with the program instructions of computer program 418 to control the one or more imaging devices 406, and optionally the rotation apparatuses 408 and 409, to capture images of the entire surface of the ball in the inspection chamber 402. The at least one processor 414 may further, also in accordance with the program 418, compare the captured images or parts of the captured images to stored images to detect deformations and/or cracks. In some embodiments, image processing techniques other than, or in addition to, image matching with stored images is used to detect the deformations and/or cracks. For example, an area scanning component 410 of the at least one imaging device 406, as shown in FIG. 4B, and/or a line scanning component 412 of the at least one imaging device 406, as shown in FIG. 4C, may be used in the imaging and image processing.

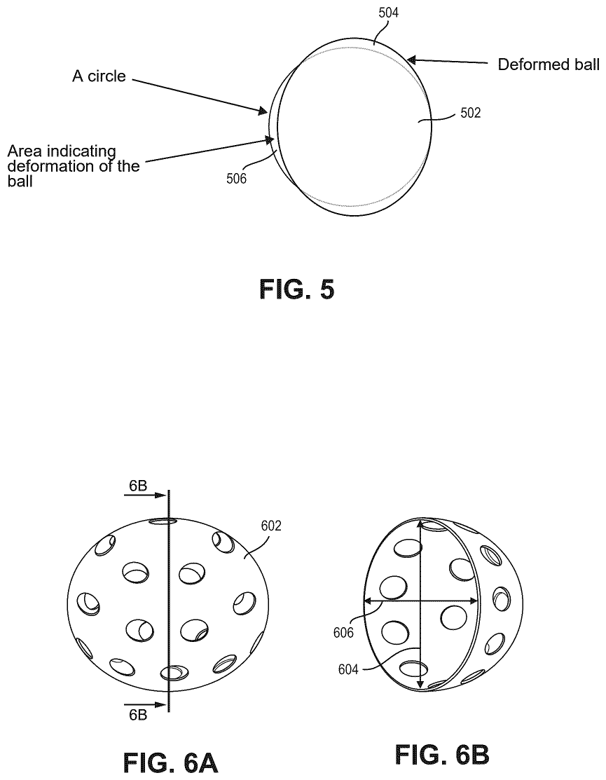

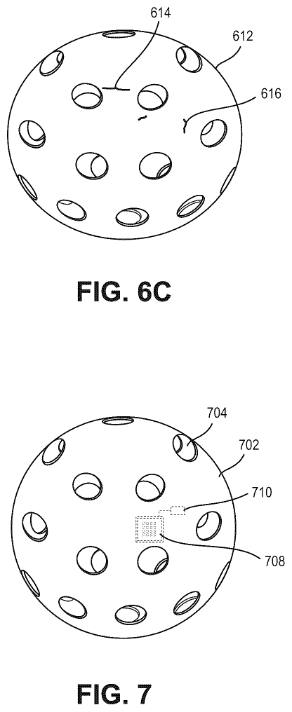

In some embodiments, the image processing by the processor 414 may include comparing the perimeter edge of the ball (e.g. using photos of the ball, using other type of radiation) from different directions with a circle representing a new ball. The mismatch area may be an indication of ball deformation. FIG. 5 shows the outline 504 of the ball, as derived from a captured image, being compared against a stored image of a standard ball or an outline 502 of a standard ball. Deviation (e.g., the area 506) between the two outlines 502 and 504 can be evaluated as potential deformities in the ball being tested. Alternatively, or additionally, the processor may compare the dimensions of the ball being tested against a set of preconfigured dimensions. FIG. 6B shows two possible diameter dimensions 604 and 606 that can be determined from a cross section of a ball 602 such as that shown in FIG. 6A.

Based on the captured area images and/or line scans, processor 414 may determine a wear-and-tear status of the ball. A predetermined scoring of the deformations (e.g., number of separate deformations and the extent of each deformation) and cracks may be combined to arrive at a grading of the ball's wear-and-tear status. For example, the status may indicate a “discard” or “do not use” status if a combined score of deformations and cracks equals or exceeds a threshold, and may indicate a “usable” status if the combined score is less than the threshold. The status may be indicated on display 420 or indicator lights 422.

For example, the mismatch area may be scored as 2%, 3%, or more. For example, a ball with more than 5% mismatch area may be identified as a defective ball. In some embodiments, a color or bar display may show the effectiveness of the ball, e.g. green (good), yellow (moderate), and red (defective). The pickleball ball may be rotated multiple times and in different directions, and the process may be repeated. This enables to determine roundness more accurately.

Example crack patterns 614 and 616 on a surface of a ball 602 are shown in FIG. 6C. Cracks are shown by dark lines. Cracks may be identified by processing captured images of the ball. Crack identification may include evaluating lines between the holes, or next to the holes. Unusual edge patterns around the holes may indicate a crack on the ball. The pickleball may be rotated multiple times and in different directions, and the process may be repeated. This enables to determine cracks all around the pickleball ball.

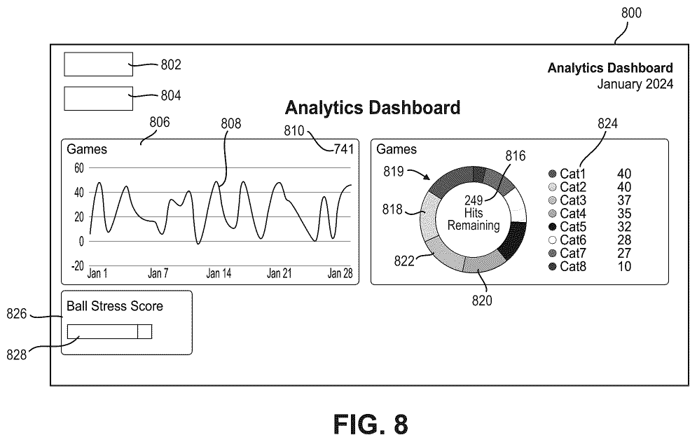

FIG. 7 shows a pickleball ball with a wear-and-tear monitoring microchip, according to some embodiments. Ball 702 may include a microchip 708 and one or more sensors 710 integrated or attached to the inner surface of the hollow spherical shell of the ball.

The sensors 710 (e.g., impact sensors and/or vibration sensors) may detect, and the microchip 708 may store in one or more counters, the number of impacts the ball is subjected to. In some embodiments, the sensors and/or the processing on the microchip may categorize each impact as to its severity (e.g., strength, how hard the ball strikes the court or how hard the paddle strike is) into two or more levels. In some embodiments, the processing on the microchip may categorize a series of successive impacts, based on the timing of the respective impacts, as a game, and maintain a count of the detected number of games. In some embodiments, one or more sensors 710 may detect the stress of the ball based on the vibrations generated in the hollow shell of the ball upon an impact, and the detected stress level may be used to update a status stored in the microchip.

In some embodiments, the microchip 708 may include an RFID tag that can be read by an RFID scanner. The counter values can be obtained by a handheld scanner (e.g., integrated in a smartphone) or the like, and may be used by a software program to generate a user-friendly display such as that shown in FIG. 8. In some other embodiments, another technology (e.g., Bluetooth) can be used to communicate between a microchip 708 and a handheld device to read the statuses currently stored in the microchip.

Embodiments of the present disclosure provide for quickly and reliably detecting whether a pickleball ball is defective and/or is likely to yield non-optimal performance. Some embodiments provide indicators incorporated into the visible outer surface of the ball such that the level of wear-and-tear is clearly indicated to the players. Some embodiments provide a pickleball ball wear-and-tear detection apparatus that can quickly indicate the level of wear-and-tear for any pickleball ball.

FIG. 8 shows an example analytics dashboard 800 that may be used to display the wear-and-tear information collected on the microchip 708 shown in FIG. 7. The dashboard may include fields 802 and 804 to identify the ball brand and model. A graph 806 may display the number of games 810 played and the level 808 of wear-and-tear imposed (e.g., based on a predetermined baseline level of wear-and-tear per game) by each game. Another graph may display a countdown 816 of the hits remaining (e.g., based on a predetermined number of maximum number of hits) and a categorization of the hits accumulated in accordance to the severity. For example, the pie chart categorization (e.g., 818, 819, 820, 822) and an accompanying legend 824 may clearly display the number of impacts imposed on the ball for each of a predetermined set of severity ranges. Another indicator 826 may display a bar graph 828 or the like showing the currently detected stress level on the ball. The dashboard 800 may be displayed in a web application and/or on a smartphone app.

Embodiments of the present disclosure are not limited to the particular construction materials, size and number of through holes, etc. of the pickleball balls. It should also be understood that further embodiments may include combinations of features of embodiments that are shown in the figures. Although various embodiments have been shown and described in detail, the claims are not limited to any particular embodiment or example.

1. A pickleball ball comprising a hollow sphere with a plurality of holes arranged on the hollow sphere and an attached or integrated wear-and-tear indicator.

2. The pickleball ball of claim 1, wherein the wear-and-tear indicator comprises a multi-layered painted indicator on the outer surface of the hollow core.

3. The pickleball ball of claim 2, wherein the multi-layered painted indicator comprises two or more layers of different materials with different durability characteristics.

4. The pickleball ball of claim 1, wherein the wear-and-tear indicator comprises a shape, text, or logo, formed with a paint of predetermined durability, on an outer surface of the hollow shell.

5. The pickleball ball of claim 4, wherein the predetermined durability is determined in terms of a number of impacts.

6. The pickleball ball of claim 1, wherein the wear-and-tear indicator comprises a first painted indicator on the outer surface of the hollow core and a second painted indicator on the outer surface of the hollow core, wherein the first painted indicator and the second indicator are configured with different durability characteristics.

7. The pickleball ball of claim 6, wherein the first painted indicator comprises a first plurality of markings distributed on the outer surface and the second painted indicator comprises a second plurality of markings distributed on the outer surface.

8. The pickleball ball of claim 6, wherein the first painted indicator comprises first one or more connected lines on the outer surface and the second painted indicator comprises second one or more connected lines on the outer surface.

9. The pickleball ball of claim 1, wherein the wear-and-tear indicator comprises a microchip integrated on the inner surface of the hollow sphere, wherein the microchip is configured to track a number of impacts, a number of games left, and/or one or more performance characteristics.

10. The pickleball ball of claim 9, wherein the tracked number of impacts are collected for each of a plurality of levels of impacts.

11. The pickleball ball of claim 9, wherein the tracked performance characteristics include a stress level of the hollow sphere.

12. The pickleball ball of claim 1, wherein the wear-and-tear indicator comprises a RFID tag integrated on the inner surface of the hollow sphere.

13. The pickleball ball of claim 12, wherein the RFID tag includes a microchip, one or more sensors, and one or more counters.

14. The pickleball ball of claim 1, wherein the wear-and-tear indicator comprises a layer of material on a wall of one or more of the holes.

15. The pickleball ball of claim 14, wherein the layer of material is configured to change a characteristic in proportion to a use of the ball.

16. The pickleball ball of claim 15, wherein the layer of material is configured to change a color and/or a texture in accordance with a use of the ball.

17. A pickleball ball wear-and-tear detector comprising an inspection area to hold the ball, an imaging device to capture one or more images of the ball in the inspection area, and a processor configured to control the imaging device to capture the one or more images of the ball.

18. The detector of claim 17, wherein the processor is further configured to rotate the ball in the inspection area and to control the imaging device to capture the one or more images in coordination with the rotation of the ball.

19. The detector of claim 17, wherein the processor is configured to detect cracks and/or deformations of the ball by comparing the captured one or more images with one or more stored images.

20. The detector of claim 17, further comprising a display and/or one or more indicator lights, wherein the processor is configured to analyze the one or more images to determine a status of the ball and to control the display and/or the one or more lights to indicate information about the determined status.
